(19) United States
(12) Patent Application Publication
(10) Pub. No.: US 2009/0310334 A1
(43) Pub. Date: Dec. 17, 2009

(54) Display with lighting and speaker

(75) Inventors: Guan-De Liou, Taipei City (TW); Stephen Tsai, Sijhih City (TW); Li-Li Lai, Taipei City (TW); Shau-Yu Huang, Taipei City (TW)

Correspondence Address: BACON & THOMAS, PLLC, 625 SLATERS LANE, FOURTH FLOOR, ALEXANDRIA, VA, 22314-1176, US

(73) Assignee: Hannspree, Inc., Taipei City (TW)

(21) Appl. No.: 12/314,174

(22) Filed: Dec. 5, 2008

(30) Foreign Application Priority Data
Jun. 17, 2008 (TW) 097122591

(51) Int. Cl. F21V 33/00

(52) U.S. Cl. 362/86

(57) ABSTRACT

A display with lighting and speaker includes a display body, a speaker body, a lighting means disposed on the speaker body, and a wire-collection casing extended outward from the speaker body and connected to the display body. The lighting means is disposed around an acoustic portion of the speaker body. The wire-collection casing receives electric wires for supplying electric power to the lighting means and the speaker body, and can move the speaker body relative to the display body. Accordingly, the display has a merit in providing illumination, sound, and images, individually or simultaneously, so as to enhance practicability.

### BACKGROUND OF THE INVENTION

1. Field of the Invention

The present invention relates to a display of multiple functions, and more particularly, to a display with lighting and speaker.

2. Description of Related Art

Computer apparatuses including desktop and notebook have been widely used in the fields such as household, office, factory, conference room, etc., wherein displays are indispensable in displaying messages and imagines to users. The displays are of the types including Cathode Ray Tube (CRT) and Liquid Crystal Display (LCD).

Currently, most LCDs have merits in not only showing images on display panels, but also producing sound, i.e. integrated with built-in speakers. Through an acoustic portion on the display, users may be satisfied with an acoustic effect by performing a multimedia program on a computer system, without the need of purchasing and mounting an extra speaker.

It is understood that the displays only integrated with speakers, as currently available in the market, cannot meet the demands for users. For instance: during commercial or engineering conferences, where the lightings are switched off, for use of the projectors. When requiring to review or key in documents, it's very difficult due to poor lighting. It is, therefore, an urge to provide a display with lighting and speaker.

### SUMMARY OF THE INVENTION

The present invention is to provide a display with lighting and speaker, comprising a display body, a speaker body, a lighting means, and a wire-collection casing. The speaker body includes an acoustic portion, and that the lighting means is disposed on the speaker body and around the acoustic portion. The wire-collection casing extends outward from the speaker body and is connected to the display body.

With the help of the above-mentioned structure, the present invention can, on the one hand, use the lighting means, simultaneously, so as to provide or enhance illumination when the display is turned on, which particularly meets demands during conference when lights are switched off; or on the other hand, when the display is turned off, the lighting means can be used as a desk lamp for reading purpose. Moreover, by means of the characteristic that the wire-collection casing can move relative to the display body, the lighting means fixed on the speaker body can be displaced so as to satisfy illumination demands in various conditions.

Electric wires for supplying electric power to the speaker body and the lighting means are received in the wire-collection casing, and are electrically connected with a circuit board in the display body, and that the speaker body can move relative to the display body through the wire-collection casing.

The speaker body may have a semi-circular contour; and that the lighting means may be an annular fluorescent lamp surrounding the acoustic portion of the speaker body, or a plurality of LEDs arrayed around the acoustic portion. The wire-collection casing may includes a flexible tube, or a convoluted bellows, so as to increase the range of illumination and the degree of freedom.

The display with lighting and speaker, according to the present invention, further includes a switch for controlling electric connections of the lighting means. The switch may be a press-button switch, and includes a press-portion protruded from the speaker body.

The display body may have a rectangular contour containing, and that the wire-collection casing may be an elongated casing and pivotally connected to one side of the display body, such that the wire-collection casing can pivot about and relative to the display body. The wire-collection casing may be arranged at right or left side, or both sides, of the display body.

Other objects, advantages, and novel features of the present invention will become more apparent from the following detailed descriptions when taken in conjunction with the accompanying drawings.

### BRIEF DESCRIPTION OF THE DRAWINGS

FIG. 1 is a perspective view illustrating a display according to a first embodiment of the present invention;

FIG. 2 is a perspective view illustrating the display according to the first embodiment of the present invention, wherein a lighting means, adjusted to a particular position;

FIG. 3 is a block diagram illustrating power connection of the display according to the first embodiment of the present invention;

FIG. 4 is a perspective view illustrating a display according to a second embodiment of the present invention; and

FIG. 5 is a perspective view illustrating a notebook display according to a third embodiment of the present invention.

### DETAILED DESCRIPTION OF THE PREFERRED EMBODIMENTS

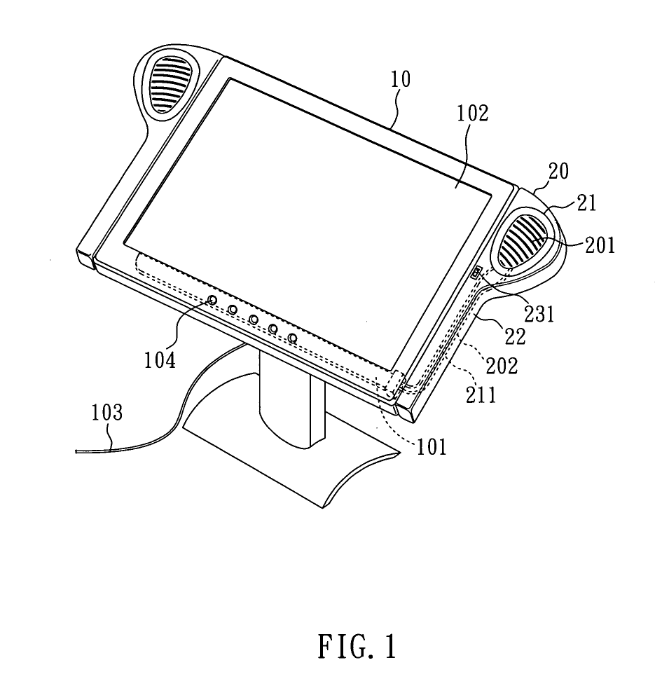

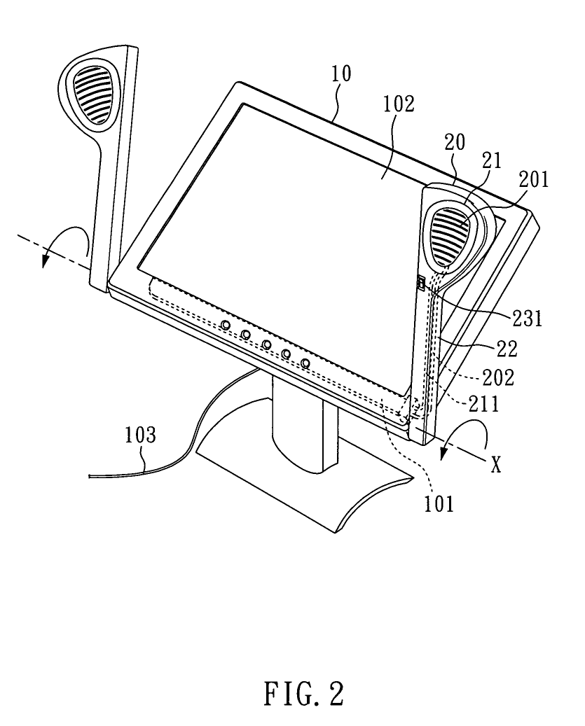

Referring to FIGS. 1 and 2, perspective views illustrating a display according to a first embodiment of the present invention, the display comprises a display body 10, a speaker body 20, a lighting means 21, and a wire-collection casing 22. The display body 10 has a rectangular contour, and contains a circuit board 101 inside for receiving electric power and driving a display panel 102 so as to display images.

The wire-collection casing 22 relates to a rectangular casing, and is made of plastic material; while the display, for its external frame, is also made of plastic material. The wire-collection casing 22 extends outward from the speaker body 20, with one end pivotally connected to one side of the display body 10, such that the wire-collection casing 22 can pivot about and relative to the display body 10. The wire-collection casing 22 may be disposed on right or left side, or both sides, of the display body 10. In the present embodiment, the wire-collection casing 22 can pivot about an axis X parallel to a bottom side of the display body 10.

Further, in the present invention, the speaker body 20 has a semi-circular contour, with one flat side aligned with a flat side of the wire-collection casing 22 so as to abut together along side of the display body 10. The speaker body 20 includes an acoustic portion 201, with an annular fluorescent lamp lighting means 21 surrounding the acoustic portion 201.

Electric wires 202,211 for supplying power to the speaker body 20 and the lighting means 21 are received in a space defined by the speaker body 20, the wire-collection casing 22 and the display body 10, where the electric wires 202,211 are physically and electrically connected to the circuit board 101 disposed in the display body 10. As a result, the speaker body 20 and the lighting means 21 share the same electric power source as the display body 10. Power supply is distributed to the speaker body 20, the lighting means 21, and the display body 10 from a power source obtained by plugging a power cord 103 of the display body 10 into a socket of the power source.

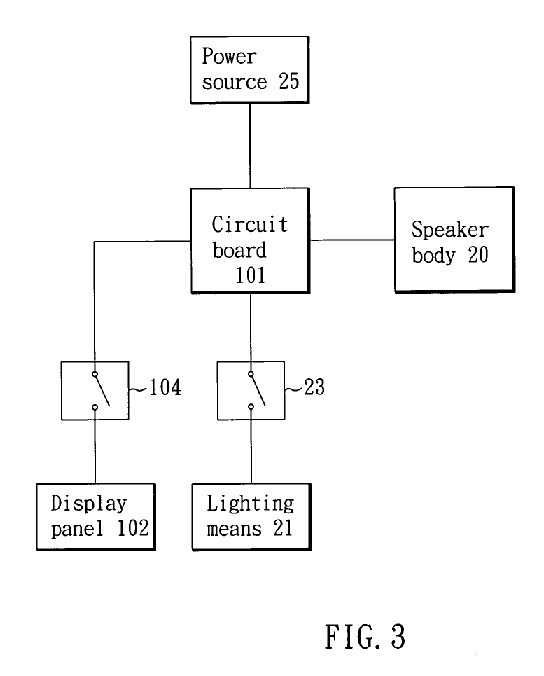

In the present embodiment, a press-button switch 23 (shown in FIG. 3) is also provided, where a press-portion 231 is protruded from the speaker body 20. The lighting means 21 can be controlled through the switch 23 for electric connections. Or when the lighting means 21 is not in use, power supply can be switched off through the switch 23.

A user may control On or Off of the display panel 102 through a screen switch 104. When the user turns on the display panel 102 for use of the display body 10, he/she can on the one hand turn on simultaneously the lighting means 21 so as to provide sufficient illumination for viewing images in the display or for when operating the display; or on the other hand, turn off the lighting means 21. In either one of the cases, the function of speaker always maintains.

Even if the user shuts off the display panel 102, not using the display body 10, the user still has an option to turn on or off the lighting means 21. This may be the case that the user employs the lighting means 21 as an illumination for reading purpose.

The speaker body 20 can pivot, along with the wire-collection casing 22, relative to the display body 10. Therefore, the lighting means 21 can be adjusted, as required, to an appropriate position for illumination so as to obtain, as well, an illumination effect.

FIG. 3 shows a relation that the display panel 102, the speaker body 20 and the lighting means 21 receive together, through the circuit board 101, supply of a power source 25. Also shown is that the switch 23 can control electric connections of the lighting means 21, and the switch 104 can control electric connections of the display panel 102.

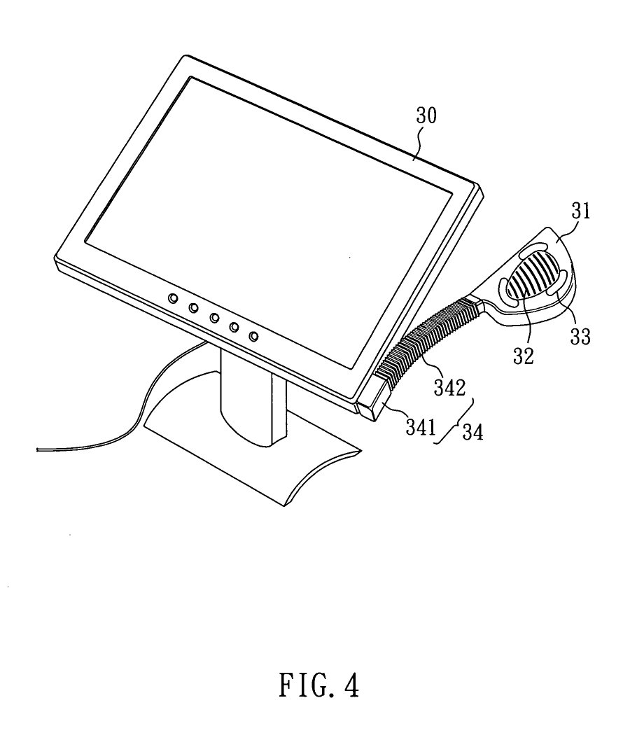

Referring to FIG. 4, a perspective view illustrating a display according to a second embodiment of the present invention, this embodiment is substantially similar to the first embodiment, except that a lighting means 33 can be one single illumination unit or an array of a plurality of illumination units, namely, one single annular fluorescent lamp or a plurality of fluorescent lamps arrayed annularly; or an individual light emitting diode (LED) or a plurality of LEDs arrayed around an acoustic portion 32 of a speaker body 31. A wire-collection casing 34 includes an auxiliary support 341 and a convoluted bellows 342. The auxiliary support 341 is disposed on the side of a display body 30, and the convoluted bellows 342 one end is connected to the speaker body 31, and, the other end is connected to the auxiliary support 341. When the lighting means 33 is moved by the convoluted bellows 342, the bending and telescoping functions of the convoluted bellows 342 will greatly increase the range of illumination and the degree of freedom.

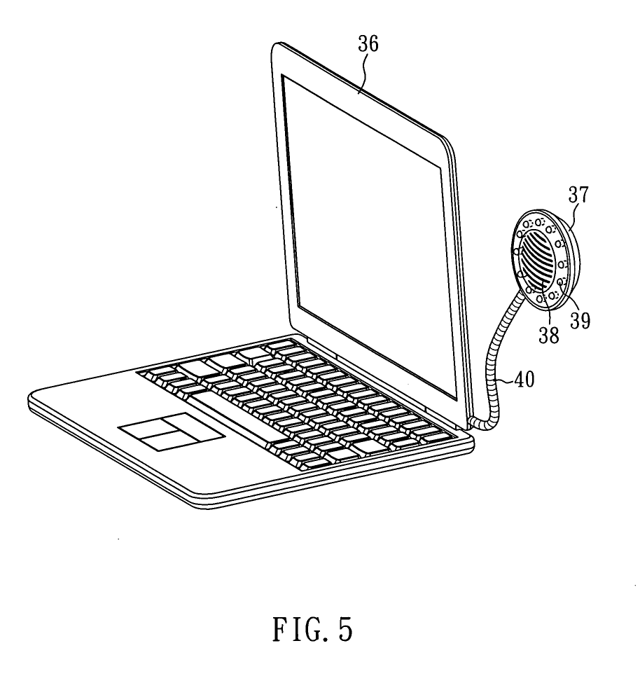

Referring to FIG. 5, a perspective view illustrating a notebook display according to a third embodiment of the present invention, the third embodiment is applied to notebook computers. A speaker body 37 has a disk-like configuration. A lighting means 39 may be constituted by an annular fluorescent lamp, or by a plurality of LEDs arrayed annularly, around an acoustic portion 38. The wire-collection casing may be flexible tube 40, for instance metal hose or rubber hose, with one end connected to the speaker body 37, and with the other end to a display body 36. Such a structural design of display also has a merit in moving the lighting means 39 with a greater degree of freedom in flexibility.

Although the present invention has been explained in relation to its preferred embodiments, it is to be understood that many other possible modifications and variations can be made without departing from the scope of the invention as hereinafter claimed.

What is claimed is:

1. A display with lighting and speaker, comprising:
a display body;
a speaker body, including an acoustic portion;
a lighting means, disposed on the speaker body and around the acoustic portion; and
a wire-collection casing, extended outward from the speaker body and connected to the display body.

2. The display with lighting and speaker as claimed in claim 1, wherein the lighting means is an annular fluorescent lamp surrounding the acoustic portion of the speaker body.

3. The display with lighting and speaker as claimed in claim 1, wherein the lighting means relates to a plurality of LEDs arrayed around the acoustic portion of the speaker body.

4. The display with lighting and speaker as claimed in claim 1, wherein the wire-collection casing is an elongated casing and pivotally connected to one side of the display body, such that the wire-collection casing can pivot about and relative to the display body.

5. The display with lighting and speaker as claimed in claim 1, wherein the wire-collection casing includes a flexible tube.

6. The display with lighting and speaker as claimed in claim 1, wherein the wire-collection casing includes a convoluted bellows.

7. The display with lighting and speaker as claimed in claim 1, wherein the lighting means is subject to a switch for controlling electric connections thereof.

8. The display with lighting and speaker as claimed in claim 7, wherein the switch includes a press-portion protruded from the speaker body.

9. The display with lighting and speaker as claimed in claim 1, wherein electric wires for supplying power to the speaker body and the lighting means are received in the wire-collection casing, and are electrically connected with a circuit board in the display body, and wherein the speaker body can move relative to the display body through the wire-collection casing.
